(19) United States
(12) Patent Application Publication
(10) Pub. No.: US 2026/0125248 A1
(43) Pub. Date: May 7, 2026

(54) FOLDABLE SUPERLIFT DEVICE, CRANE, AND TENSIONING CONTROL SYSTEM AND METHOD

(71) Applicant: XUZHOU HEAVY MACHINERY CO., LTD., Jiangsu (CN)

(72) Inventors: Honggang DING, Jiangsu (CN); Bo LI, Jiangsu (CN); Sisheng GU, Jiangsu (CN); Yuqin FU, Jiangsu (CN); Xiaohu QIN, Jiangsu (CN); Dazhong CHENG, Jiangsu (CN)

(73) Assignee: XUZHOU HEAVY MACHINERY CO., LTD., Jiangsu (CN)

(21) Appl. No.: 19/439,433

(22) Filed: Jan. 4, 2026

Related U.S. Application Data
(63) Continuation of application No. PCT/CN2023/138615, filed on Dec. 14, 2023.

(30) Foreign Application Priority Data
Jul. 5, 2023 (CN) 202310815925.0

(51) Int. Cl. B66C 23/68

(52) U.S. Cl. CPC B66C 23/68

(57) ABSTRACT

A superlift device includes a superlift boom, and a superlift base and a superlift winch disposed at two ends of the superlift boom, where the superlift boom includes a fixed boom connected to the superlift base and a folding boom connected to the superlift winch, and the folding boom is connected to the fixed boom via a pivot shaft, achieving length adjustment of the superlift boom by means of unfolding and folding. A crane, a multi-angle tensioning control system, and a multi-angle tensioning control method include the foldable superlift device.

### CROSS-REFERENCE TO RELATED APPLICATION

This application is a continuation of International Application of PCT application serial no. PCT/CN 2023/138615, filed on Dec. 14, 2023 which claims the priority benefit of Chinese application no. 202310815925.0, filed on Jul. 5, 2023. The entirety of each of the above-mentioned patent applications is hereby incorporated by reference herein and made a part of this specification.

### TECHNICAL FIELD

The present application relates to the technical field of construction machinery, and in particular, to a foldable superlift device, a crane, and a tensioning control system and method.

### BACKGROUND

With the continuous improvement of crane technology and higher requirements from customers for product performance, the overall vehicle weight has not increased due to slight restrictions on single axle loads, while the boom structure design tends to adopt a lightweight design. This leads to an increased boom length and higher performance requirements, while the boom cross-section and plate thickness are becoming smaller and smaller. If limited to the previously designed superlift device with a fixed length, the improvement in lifting performance is limited, making it difficult for the product to meet customer needs; product competitiveness will also decline, directly affecting the enterprise's product sales.

However, superlift devices currently used in the market still adopt a fixed-length structural form. This structural form cannot enable the crane boom to fully utilize the performance of the product boom structure, cannot better improve boom strength and stiffness, and fails to meet customer demands for high performance. In addition, since the superlift device is installed on the basic boom of the crane boom, the superlift device is limited by the length of the basic boom; the length of the superlift device cannot be greater than the length of the basic boom, so fixed-length superlift devices are constrained by installation dimensions.

In the prior art, there are mainly two forms of superlift devices. The first is the assembly type, which achieves a change in the length of the superlift device during use by adding an extension section structure or a similar structure between the superlift boom and the superlift winch. The second is the telescopic type; the telescopic structure is similar to the telescoping system of a crane boom, where the telescoping system uses a cylinder or ropes for extension and retraction, retracting fully or partially during transit, and extending outward to the working boom length during use.

For a superlift device of the assembly type, the length change of the superlift device is realized by adding an assembly component to the superlift device during use. However, after lengthening, it no longer meets the overall machine space requirements for transit, and the installed component needs to be removed again so that the superlift device can be fully stowed on the crane boom. Moreover, the added component needs to be transported separately. This form not only increases transportation costs but also increases assembly and disassembly time before and after use, resulting in low operational efficiency and poor convenience of use.

For a superlift device of the telescopic type, the length is adjustable during use, but the superlift device adopts a telescopic cylinder with one end connected to the upper part of the superlift device and the other end connected to the lower part of the superlift device. Since the length of superlift devices is mostly over 10 m, the telescopic cylinder used is long, heavy, and has high cost and low cost performance. These characteristics restrict the development and promotion of the superlift device.

Meanwhile, in the prior art, the superlift has only one unfolding angle. During tensioning, the superlift can only adjust its influence on the boom by a single angle. The unfolding angle is singular, and under the condition of a fixed superlift length, the unfolding angle cannot be adjusted in multiple stages. During use, the unfolding angle cannot be adjusted according to the boom length of the crane boom, and the two cannot achieve optimal matching. Superlift tensioning performed under this single-angle form provides limited improvement to the boom performance and cannot fully enhance the performance of the product.

### SUMMARY OF INVENTION

Objectives of the present application: In order to overcome the deficiencies mentioned in the background section, a first objective of the present application is to disclose a foldable superlift device, which can achieve three different working forms by means of multi-stage adjustment forms of folding/unfolding.

A second objective is to disclose a crane including the above-mentioned foldable superlift device. By means of the folding/unfolding of the superlift device, and in combination with a main boom length and combination, multi-stage unfolding of the superlift device can be adopted to switch between different unfolding working states.

A third objective is to disclose a multi-angle tensioning control system including the above-mentioned foldable superlift device.

A fourth objective is to disclose a multi-angle tensioning control method involving the above-mentioned foldable superlift device.

Technical solutions: The present application discloses a foldable superlift device. The foldable superlift device includes a superlift boom, and a superlift base and a superlift winch disposed at two ends of the superlift boom, where the superlift boom includes a fixed boom connected to the superlift base and a folding boom connected to the superlift winch, and the folding boom is connected to the fixed boom via a pivot shaft, achieving length adjustment of the superlift boom by means of unfolding and folding.

Further, a first connection point is provided on one side of joining ends of the fixed boom and the folding boom, and connection is made via a fixed pivot shaft.

Further, a second connection point and a third connection point are also respectively provided on the other side of the joining ends of the fixed boom and the folding boom and on boom sides of the fixed boom and the folding boom, and connections are made via pin assemblies; when the fixed boom and the folding boom are not folded, a position of the second connection point is fixed via the pin assembly; when the fixed boom and the folding boom are fully folded, a position of the third connection point is fixed via the pin assembly.

Further, the pin assembly is an automatic insertion-and-extraction device.

Further, the fixed boom and the folding boom are connected via a crank-rocker assembly, and driving is realized by a drive element to control the crank-rocker assembly to swing, thereby driving the folding boom to perform folding/unfolding actions.

A crane is provided. The foldable superlift device mentioned above is provided on a telescopic main boom of the crane.

A multi-angle tensioning control system is provided. The multi-angle tensioning control system, implemented based on the above-mentioned crane, includes: a force limiter system, a display system, a boom position detection device, a superlift first angle sensor, a superlift second angle sensor, a superlift winch encoder, and a superlift tension sensor.

A multi-angle tensioning control method is provided. The multi-angle tensioning control method, employing the multi-angle tensioning control system mentioned above, includes the following steps:
S1, completing installation of the foldable superlift device, and checking whether the crane possesses boom raising conditions;
S2, unlocking a cylinder and a winch of the superlift device, so that the main boom possesses boom extending conditions;
S3, extending the main boom to a specified boom length combination, and luffing to a corresponding main boom angle;
S4, performing, according to the boom length combination of the main boom, first-stage unfolding of the superlift device to make a first-stage unfolding angle α reach a specified angle, where the first-stage unfolding angle is an included angle between the fixed boom and the main boom;
S5, performing, according to the boom length combination of the main boom, second-stage unfolding of the superlift device to make a second-stage unfolding angle β reach a specified angle, where the second-stage unfolding angle is an included angle between the fixed boom and the folding boom;
S6, re-confirming whether the two-stage unfolding angles of the superlift device match the corresponding boom length combination of the main boom, and if not matching, performing readjustment;
S7, performing superlift tensioning after confirming that the two-stage unfolding angles of the superlift device are correct, and locking the winch when the winch reaches a specified rotation angle;
S8, detecting, by the superlift tension sensor, whether a superlift tensioning force meets a design requirement; if not met, unlocking the superlift winch, adjusting a number of winch teeth, and re-tensioning and locking; and
S9, performing load lifting after the tensioning force meets a design value.

Beneficial effects: Compared with the prior art, the advantages of the present application are as follows: First, within a limited space, the fixed-length type superlift device is designed as a foldable device, thereby increasing the effective usage length and improving the strength and stiffness of the boom; through optimized matching with a boom length combination, a substantial improvement in the lifting capacity of the product is thereby achieved. Second, through the foldable superlift device, second-stage unfolding of the superlift is realized, which can change the lateral unfolding range to a greater extent. During use, different first-stage and second-stage unfolding working states of the superlift can be switched according to different crane boom length combinations, so as to adjust the effective length and the unfolding angle of the superlift, thereby causing the superlift length to correspond to the crane boom length to achieve optimal matching. This fully improves the strength and stiffness of the boom, reduces forces acting on the superlift itself, and improves the safety and stability of the boom.

### BRIEF DESCRIPTION OF DRAWINGS

FIG. 1 is a structural diagram of a foldable superlift device according to the present application;

FIG. 2 is a diagram showing three states of a foldable superlift device according to the present application;

FIG. 3 is a diagram showing the folding principle of a foldable superlift device according to the present application;

FIG. 4 is a structural diagram of a crane according to the present application;

FIG. 5 shows four working states of a superlift device on a crane according to the present application; and

FIG. 6 is a flowchart of a multi-angle tensioning control method according to the present application.

### DESCRIPTION OF EMBODIMENTS

The technical solutions of the present application will be further described below with reference to the drawings and examples.

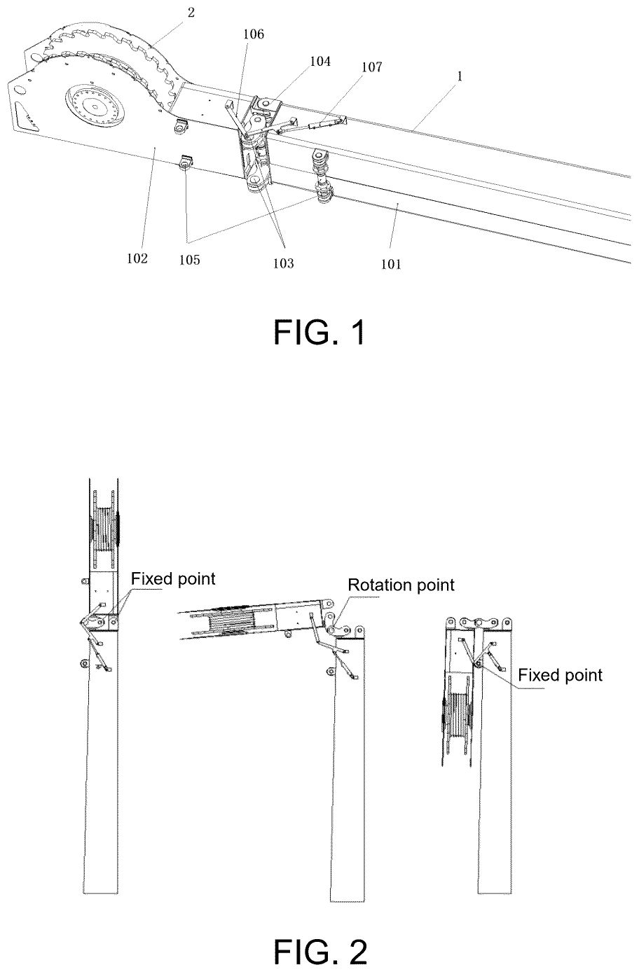

FIG. 1 shows a foldable superlift device, and the superlift device includes a superlift boom 1, and a superlift base and a superlift winch 2 disposed at two ends of the superlift boom. The superlift boom 1 includes a fixed boom 101 connected to the superlift base and a folding boom 102 connected to the superlift winch 2. The folding boom 102 is connected to the fixed boom 101 via a pivot shaft and is capable of folding sideways via the pivot shaft, achieving length adjustment of the superlift boom 1 by means of unfolding and folding.

A first connection point 103 is provided on one side of joining ends of the fixed boom 101 and the folding boom 102, and connection is made via a fixed pivot shaft. A second connection point 104 and a third connection point 105 are also respectively provided on the other side of the joining ends of the fixed boom 101 and the folding boom 102 and on boom sides of the fixed boom 101 and the folding boom 102, and connections are made via pin assemblies. The pin assembly is an automatic insertion-and-extraction device, preferably a hydraulic telescopic cylinder as an actuating element, and capable of two-stage or multi-stage extension and retraction. When the fixed boom 101 and the folding boom 102 are not folded, the position of the second connection point 104 is fixed via the pin assembly; when the fixed boom 101 and the folding boom 102 are fully folded, the position of the third connection point 105 is fixed via the pin assembly.

The fixed boom 101 and the folding boom 102 are connected via a crank-rocker assembly 106, and driving is realized by a drive element 107. The drive element 107 is preferably a hydraulic telescopic cylinder, which controls the crank-rocker assembly 106 to swing, thereby driving the folding boom 102 to perform folding/unfolding actions.

The fixed boom 101 may also be configured as a multi-section structure, with sections connected via pivot shafts; the specific implementation structure of the pivot shaft is consistent with the pivot shaft structure between the fixed boom 101 and the folding boom 102 described above, enabling the folding boom 102 to achieve more than two folding actions.

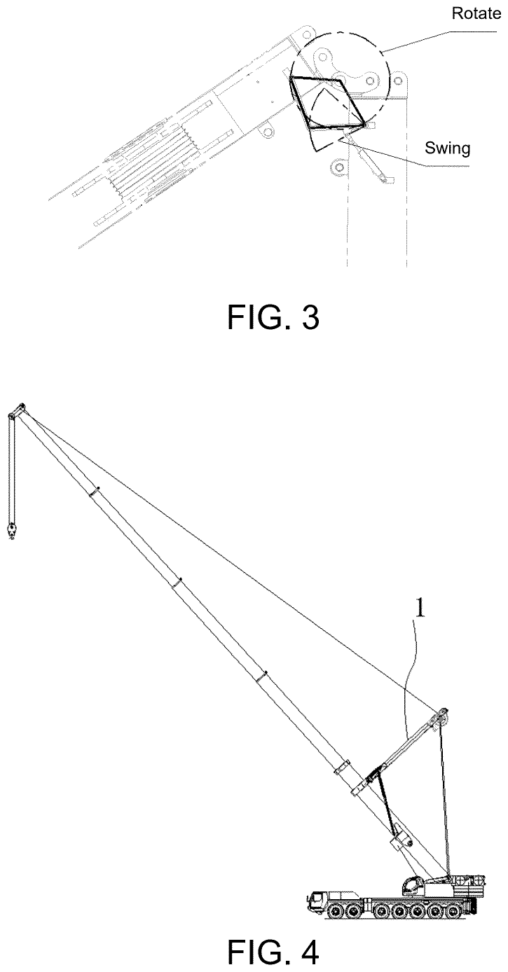

As shown in FIG. 2, the length of the fixed structure and the length of the foldable structure are for illustration only, and actual lengths may be changed according to design requirements. In this patent, the design of the position of the superlift winch is likewise not limited to the superlift foldable boom in this patent, but may also be designed at the superlift fixed boom, with the specific position determined according to design requirements. The extension and retraction movement of the cylinder is converted into rotational movement of the superlift foldable boom via the crank-rocker assembly 106, and the motion mechanism model is simplified as a crank-rocker mechanism model, as shown in FIG. 3.

FIG. 4 shows a crane, and the above-mentioned foldable superlift device is provided on a telescopic main boom of the crane. The superlift device is installed at the head of a basic boom of the main boom, and during road transport and short-distance heavy-load transit, the superlift device is stowed flat on the basic boom. Constrained by the length of the basic boom and the position of an operator's cab, the structural length of the superlift in a transit state is limited, and the length of the superlift cannot be changed without limit. In this patent, assuming the maximum superlift structural length in the transit state is CQ_L, then for a scheme with a fixed superlift length, the maximum design value of the superlift length is CQ_L; for a telescopic superlift structure design scheme, since the superlift adopts a two-section structure with inner and outer sections and the overlap ratio thereof cannot be less than 0.1, the maximum design value of the telescopic superlift length is 1.7*CQ_L. For the patent scheme of the present application, the folding superlift structure can achieve an effective total length of 2*CQ_L.

In general products, for every 10% increase in superlift length, performance increases by 8% to 12%. Compared with the fixed-length superlift structure scheme, the foldable superlift scheme improves performance by about 90%; compared with the telescopic superlift scheme, the foldable superlift scheme improves performance by about 30%. According to the above comparison, the foldable superlift scheme is far superior to the other two superlift schemes in terms of performance improvement.

In addition, adopting the foldable superlift device can significantly increase its own length and also avoid constraints of overall machine space on superlift installation; during installation and heavy-load transit, the foldable portion of the superlift device can be folded to meet assembly dimensions. In this state, it can also be ensured that the height of the overall machine does not exceed the standard road height limit of 4 m. Compared with the scheme of lengthening the superlift and making the superlift tilt up to exceed the height limit of the overall machine in a transport transit state, this patent possesses good trafficability and transit transport economy.

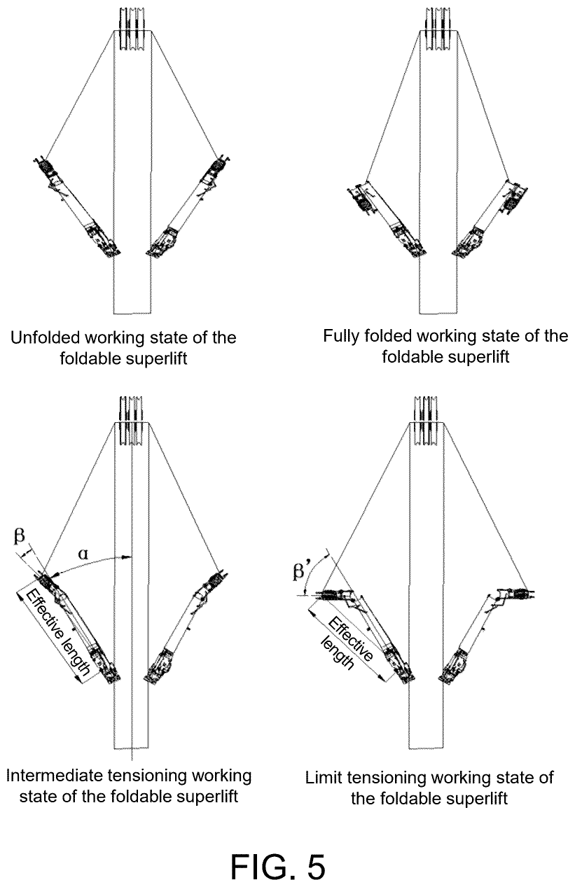

As shown in FIG. 5, the combination of the foldable superlift device and the main boom provides multiple working states, specifically: a fully unfolded working state, a fully folded working state, an intermediate tensioning working state, and a limit tensioning working state.

The fully unfolded working state and the limit tensioning state are two limit states of superlift tensioning during lifting operations, while the intermediate tensioning working state lies between the above two states; that is, a superlift second-stage unfolding angle in the intermediate tensioning working state, β, is a certain value between the angle of 0° and β′ in the limit tensioning working state. According to a product design state, the second-stage unfolding angle in the limit tensioning working state, β′, can reach a maximum of a first-stage unfolding angle α. The fully folded state is mainly used in processes such as component installation and transit transport.

By means of the foldable mechanism, second-stage unfolding of the superlift is realized, which can change the lateral unfolding range to a greater extent. During use, different first-stage and second-stage unfolding working states of the superlift can be switched according to different crane boom length combinations, so as to adjust the effective length and the unfolding angle of the superlift, thereby causing the superlift length to correspond to the crane boom length to achieve optimal matching. This fully improves the strength and stiffness of the boom, reduces forces acting on the superlift itself, and improves the safety and stability of the boom.

A multi-angle tensioning control system, implemented based on the above-mentioned crane, includes: a force limiter system, a display system, a boom position detection device, a superlift first angle sensor, a superlift second angle sensor, a superlift winch encoder, and a superlift tension sensor, among other components.

The force limiter system is an independent safety operating system controlled by a computer on the crane. The force limiter system is capable of automatically detecting a mass hoisted by the crane as well as a main boom angle, a superlift tensioning force, and superlift two-stage unfolding angles, and is capable of displaying data on the display system.

The boom position detection device is configured to detect the position of each boom section of the main boom and whether a boom pin is inserted, and to determine a main boom combination and a main boom length. Through detection of the main boom length and combination, a corresponding superlift tensioning scheme is further determined, that is, a corresponding first-stage unfolding angle, second-stage unfolding angle, and tensioning force of the superlift.

The superlift first angle sensor is configured to detect the unfolding angle of the superlift fixed boom relative to the main boom, which is the first-stage unfolding angle α of the superlift; the superlift second angle sensor is configured to detect the unfolding angle of the superlift foldable boom relative to the superlift fixed boom, that is, the second-stage unfolding angle β. Preferably, matching different main boom lengths and different combinations with different first-stage and second-stage unfolding angles can improve boom performance to a greater extent. The superlift angle sensors are located on the superlift fixed boom and the superlift foldable boom, respectively.

The superlift winch encoder is configured to detect and record the number of teeth of the current winch and the corresponding winch rotation angle. Such data is matched with the main boom length and combination, thereby better and more effectively improving the strength and stiffness of the boom. The superlift winch encoder is located on the superlift winch.

Before a lifting operation, a control system realizes tensioning of the foldable superlift by means of detection and control of the respective angle sensors and the superlift winch angle.

In this patent, the maximum bearing capacity of the boom is achieved by optimizing and matching the mutual relationship between values of the superlift first-stage and second-stage unfolding angles and different boom lengths; during tensioning control, strict identification and detection of the first-stage unfolding angle and the second-stage unfolding angle are required to ensure application safety. Different first-stage unfolding angles and second-stage unfolding angles achieve different effective superlift lengths.

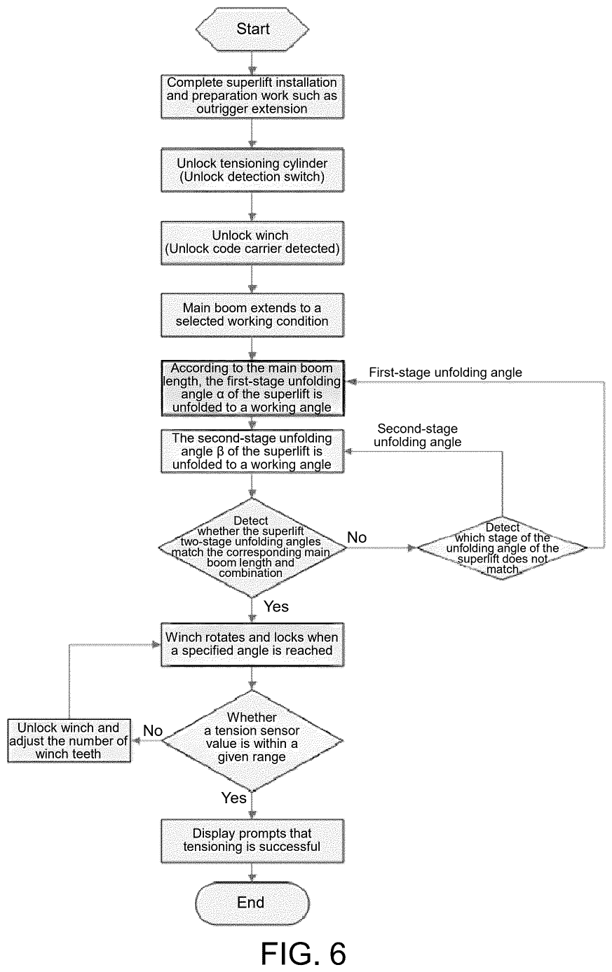

As shown in FIG. 6, a multi-angle tensioning control method according to the present application includes the following steps:
S1, completing installation of the foldable superlift device, and checking whether the crane possesses boom raising conditions;
S2, unlocking a cylinder and a winch of the superlift device, so that the main boom possesses boom extending conditions;
S3, extending the main boom to a specified boom length combination, and luffing to a corresponding main boom angle;
S4, performing, according to the boom length combination of the main boom, first-stage unfolding of the superlift device to make a first-stage unfolding angle α reach a specified angle, where the first-stage unfolding angle is an included angle between the fixed boom and the main boom;
S5, performing, according to the boom length combination of the main boom, second-stage unfolding of the superlift device to make a second-stage unfolding angle β reach a specified angle, where the second-stage unfolding angle is an included angle between the fixed boom and the folding boom;
S6, re-confirming whether the two-stage unfolding angles of the superlift device match the corresponding boom length combination of the main boom, and if not matching, performing readjustment;
S7, performing superlift tensioning after confirming that the two-stage unfolding angles of the superlift device are correct, and locking the winch when the winch reaches a specified rotation angle;
S8, detecting, by the superlift tension sensor, whether a superlift tensioning force meets a design requirement; if not met, unlocking the superlift winch, adjusting a number of winch teeth, and re-tensioning and locking; and
S9, performing load lifting after the tensioning force meets a design value.

After use of the superlift device is completed, the superlift winch needs to be unlocked first to release the tensioning state before extension and retraction actions of the boom can be performed.

What is claimed is:

1. A foldable superlift device, comprising a superlift boom, and a superlift base and a superlift winch disposed at two ends of the superlift boom, wherein the superlift boom comprises a fixed boom connected to the superlift base and a folding boom connected to the superlift winch, and the folding boom is connected to the fixed boom via a pivot shaft, achieving length adjustment of the superlift boom by unfolding and folding.

2. The foldable superlift device according to claim 1, wherein a first connection point is provided on one side of joining ends of the fixed boom and the folding boom, and connection is made via a fixed pivot shaft.

3. The foldable superlift device according to claim 2, wherein a second connection point and a third connection point are also respectively provided on the other side of the joining ends of the fixed boom and the folding boom and on boom sides of the fixed boom and the folding boom, and connections are made via pin assemblies; when the fixed boom and the folding boom are not folded, a position of the second connection point is fixed via the pin assembly; when the fixed boom and the folding boom are fully folded, a position of the third connection point is fixed via the pin assembly.

4. The foldable superlift device according to claim 3, wherein the pin assembly is an automatic insertion-and-extraction device.

5. The foldable superlift device according to claim 4, wherein the fixed boom and the folding boom are connected via a crank-rocker assembly, and driving is realized by a drive element to control the crank-rocker assembly to swing, thereby driving the folding boom to perform folding/unfolding actions.

6. A crane, comprising the foldable superlift device according to claim 5, wherein the foldable superlift device is provided on a telescopic main boom of the crane.

7. A multi-angle tensioning control system, implemented based on the crane according to claim 6, the multi-angle tensioning control system comprising: a force limiter system, a display system, a boom position detection device, a superlift first angle sensor, a superlift second angle sensor, a superlift winch encoder, and a superlift tension sensor.

8. A multi-angle tensioning control method, employing the multi-angle tensioning control system according to claim 7, the multi-angle tensioning control method comprising following steps:
S1, completing installation of the foldable superlift device, and checking whether the crane possesses boom raising conditions;
S2, unlocking a cylinder and a winch of the superlift device, so that the main boom possesses boom extending conditions;
S3, extending the main boom to a specified boom length combination, and luffing to a corresponding main boom angle;
S4, performing, according to the boom length combination of the main boom, first-stage unfolding of the superlift device to make a first-stage unfolding angle α reach a specified angle, wherein the first-stage unfolding angle is an included angle between the fixed boom and the main boom;
S5, performing, according to the boom length combination of the main boom, second-stage unfolding of the superlift device to make a second-stage unfolding angle β reach a specified angle, wherein the second-stage unfolding angle is an included angle between the fixed boom and the folding boom;
S6, re-confirming whether the two-stage unfolding angles of the superlift device match the corresponding boom length combination of the main boom, and if not matching, performing readjustment;
S7, performing superlift tensioning after confirming that the two-stage unfolding angles of the superlift device are correct, and locking the winch when the winch reaches a specified rotation angle;
S8, detecting, by the superlift tension sensor, whether a superlift tensioning force meets a design requirement; if not met, unlocking the superlift winch, adjusting a number of winch teeth, and re-tensioning and locking; and
S9, performing load lifting after the tensioning force meets a design value.
